(19) United States
(12) Patent Application Publication
(10) Pub. No.: US 2025/0167348 A1
(43) Pub. Date: May 22, 2025

(54) BATTERY TEMPERATURE CONTROL SYSTEM AND MOTOR VEHICLE

(71) Applicant: KAUTEX TEXTRON GmbH & Co. KG, Bonn (DE)

(72) Inventors: Gero Mimberg, Koln (DE); Moritz Lipperheide, Bonn (DE)

(21) Appl. No.: 18/839,297

(22) PCT Filed: Feb. 14, 2023
(86) PCT No.: PCT/EP2023/053561

§ 371 Date: Aug. 16, 2024

(30) Foreign Application Priority Data
Feb. 22, 2022 (DE) 10 2022 104 201.4

(51) Int. Cl. H01M 10/6568; B60L 58/26; B60L 58/27; H01M 10/613; H01M 10/615; H01M 10/625; H01M 10/63; H01M 10/6569

(52) U.S. Cl. CPC H01M 10/6568; B60L 58/26; B60L 58/27; H01M 10/613; H01M 10/615; H01M 10/625; H01M 10/63; H01M 10/6569; H01M 2220/20

(57) ABSTRACT

A temperature control system for controlling the temperature of a traction battery in a motor vehicle with a heat transfer medium in a temperature control circuit. The temperature control system includes a battery housing which forms an enclosed interior with at least one receiving position for a battery cell. A lower region of the battery housing receives the heat transfer medium. A heat exchanger dissipates heat from the heat transfer medium to the environment surrounding the heat exchanger. A collection vessel receives the heat transfer medium. A pump conveys the heat transfer medium. An equalization volume is fluidically connected to an upper region of the collection vessel.

The invention relates to a temperature control system and a motor vehicle.

Various types of high-performance batteries are known from the prior art. In high-performance batteries such as those used, for example, as traction batteries in motor vehicles with electric drives, high levels of power are converted during charging and discharging. Such high-performance batteries can currently be operated with voltages of up to several hundred volts or even up to 1,000 volts. In addition, the charging and discharging of currents of several hundred amperes up to 1,000 amperes can currently occur. In principle, higher voltages and/or currents are also possible in future developments.

In the high-performance batteries, the strong charging and discharging currents cause thermal losses which lead to the high-performance batteries heating up. In order to protect the batteries from thermal damage and to achieve high efficiency, it is important to keep the high-performance batteries within a desired temperature range. In order to avoid exceeding the temperature range, heat must be removed from the batteries. This is all the more important, the stronger the currents and the associated greater thermal losses, so that the batteries remain in the desired temperature range even with such large currents. The current battery cells using lithium-ion technology work best in a narrow temperature range with great temperature homogeneity and low temperature fluctuation within and between the battery cells. A reliable operation of the high-performance batteries and a long service life with consistent performance can be achieved under such conditions.

In order to ensure these conditions and to avoid exceeding the temperature range, the battery cells of the current high-performance batteries are cooled at least in phases during operation, i.e., during charging and/or discharging. Different types of cooling are currently used. For example, liquid cooling involves a heat exchanger through which a liquid heat transport medium flows. The heat exchanger is usually arranged below the battery cells, with the heat exchanger being thermally conductively connected to the battery cells via a contact heat transfer. The heat capacity of the liquid heat transport medium is used to absorb the heat emitted by the battery cells or the battery as a whole via a temperature difference and to release it into the environment either directly or via an air-conditioning circuit. Electrically conductive water or a likewise electrically conductive water-glycol mixture is used as the heat transport medium, for example, which is why a reliable separation of the heat transport medium from the battery cells is required.

A similar cooling can also be realized with air as the heat transport medium. Since air, unlike water, is not electrically conductive, the battery cells can be in direct contact with the heat transport medium and, for example, be overflown by it. A heat exchanger is therefore not absolutely necessary.

In the systems currently available, the heat transport medium circulates actively in order to dissipate the heat dissipated by convection. In an active circulation, the heat transport medium is actively circulated in order to dissipate the heat from the battery cells.

As a further development of a liquid cooling process with a heat exchanger that is in contact with the battery cells, the liquid heat transport medium can be evaporated by the heat absorption from the heat exchanger, which leads to a higher heat transfer and, due to the evaporation enthalpy, to a high heat absorption per mass of the heat transport medium. After a condensation, the heat transport medium can be returned to the heat exchanger in the liquid state.

There are also some cooling systems in development with a liquid heat transport medium, e.g., in industrial applications for high-voltage traction batteries, that do not have a heat exchanger that is in contact with the battery cells. Comparable to the use of air as a heat transport medium, cooling is effected by a direct flow of the liquid heat transport medium around the components to be cooled. An important property of the liquid heat transport medium is therefore its dielectricity, since the heat transport medium is in direct contact with the battery cells, i.e., with electrically conductive and potential-carrying components. In addition, the evaporation enthalpy of the dielectric, liquid heat transport medium, and the associated high heat transfer can also be used if the heat transport medium evaporates during the heat transfer due to the heat input from the battery cells to be cooled. Such cooling is referred to as two-phase immersion cooling. If there is no at least partial phase change of the heat transfer medium in the cooling circuit, this can also be referred to as single-phase immersion cooling.

The object of the invention is that of providing an improvement over or an alternative to the prior art.

According to a first aspect of the invention, the object is achieved by a temperature control system for controlling the temperature of a traction battery of a motor vehicle with a heat transfer medium in a temperature control circuit, comprising:
a battery housing which forms an enclosed interior with at least one receiving position for a battery cell, wherein a lower region of the battery housing is designed to receive the heat transfer medium;
a heat exchanger which is designed to dissipate heat from the heat transfer medium to the environment surrounding the heat exchanger,
a collecting container for receiving the heat transfer medium,
a pump for conveying the heat transfer medium, and
a compensation volume which is fluidically connected to an upper region of the collecting container.

In this regard, the following is explained conceptually:

It is first expressly noted that, in the context of the present patent application, indefinite articles, and numbers such as “one,” “two,” etc., should generally be understood as being “at least” statements, i.e., as “at least one . . . ,” “at least two . . . ,” etc., unless it is clear from the relevant context or it is obvious or technically compelling to a person skilled in the art that only “exactly one . . . ,” “exactly two . . . ,” etc., can be meant.

In the context of the present patent application, the expression “in particular” should always be understood as introducing an optional, preferred feature. The expression should not be understood to mean “specifically” or “namely.”

A “temperature control system” is understood to mean a device through which fluid can flow and which is designed to control the temperature of, in particular to cool and/or heat, a traction battery of a motor vehicle with a heat transfer medium in at least one “temperature control circuit.” The temperature control system can have a heat transfer medium.

The temperature control system essentially consists of a battery housing, a heat exchanger, and a pump. The temperature control system can have a collecting container. The temperature control system can have an expansion tank.

Preferably, the temperature control power required by a traction battery can be provided by means of a temperature control system and transported into and/or out of a battery housing by a designated heat transfer medium by its temperature in a temperature control circuit being changed.

In a temperature circuit, the pump can be fluidically connected directly or indirectly to the battery housing. The pump can be arranged directly or indirectly in the flow direction of the heat transfer medium upstream or downstream of the fluid inlet of the battery housing. The battery housing can be fluidically connected directly or indirectly to the heat exchanger. The heat exchanger can be fluidically connected directly or indirectly to the collecting container. The collecting container can be fluidically connected directly or indirectly to the pump.

Individual components of the temperature control circuit can optionally be connected to each other by lines. This allows the components of the temperature control circuit to be arranged at different positions within a motor vehicle.

Functionally interconnected components of the temperature control circuit can also be arranged directly adjacent to one another so that individual, multiple, or all lines can be dispensed with. The pump can be arranged adjacent to the battery housing and/or the collecting container or can be part of a line between the battery housing and the collecting container or part of the collecting container or part of the battery housing. The heat exchanger can be located adjacent to the battery housing or can be part of the battery housing. The collecting container can be located adjacent to the heat exchanger or can be part of the heat exchanger.

In particular, individual components of the temperature control circuit can be directly connected to one another in such a way that the temperature control circuit has, at least in terms of components, a common, coherent structure, or the temperature control circuit, as at least a component, can be designed at least in part as an integral component. This means that the temperature control circuit can be arranged at least in part in one piece in a motor vehicle. In addition, a temperature control circuit designed at least in part as an integral component can be particularly easily installed in a motor vehicle, removed from a motor vehicle, and replaced in a motor vehicle.

A “heat transfer medium” is understood to mean, in particular, a fluid which can be used to transport heat and/or cold by means of a volume flow of the heat transfer medium, wherein the heat transfer medium can have different temperature states. In particular, the heat transfer medium can be a gaseous and/or liquid substance or a gaseous and/or liquid substance mixture.

The heat transfer medium can expediently be designed as a “dielectric” heat transfer medium. A dielectric heat transfer medium is not electrically conductive, so it can act as an insulator between individual bodies around which a dielectric heat transfer medium flows. In particular, an electrical insulation can be formed between individual battery cells if the dielectric heat transfer medium connects them to each other.

A “battery housing” is understood to mean, in particular, a structure which forms an enclosed interior space with at least one receiving position for a battery cell, and which can have at least one battery cell.

The battery housing may have a “lower region.” The lower region of the battery housing can also extend over the lower 10% of a height extension of the battery housing, wherein the height extension is understood to mean the absolute height extension from the lowest point of the battery housing to the highest point of the battery housing, preferably over the lower 20% of the height extension, again preferably over the lower 30% of the height extension, again preferably over the lower 40% of the height extension, and particularly preferably over the lower 50% of the height extension.

The lower region of the battery housing can be designed to accommodate the designated liquid heat transfer medium located in the battery housing.

In the particularly preferred embodiment of a temperature control system designed for two-phase immersion cooling, the lower region of the battery housing can be designed to accommodate a liquid phase of the heat transfer medium. Preferably, a mixed phase and/or a gaseous phase of the heat transfer medium can be accommodated in a region above the lower region of the battery housing. In other words, an evaporation device can be arranged above the lower region of the battery housing.

The fluid inlet of the battery housing can be arranged in the lower region of the battery housing.

The fluid inlet of the battery housing can be arranged in the lower region of the battery housing.

The battery housing may have an “upper region.” The upper region of the battery housing can also extend over the upper 10% of the height extension of the battery housing, preferably over the upper 20% of the height extension, again preferably over the upper 30% of the height extension, again preferably over the upper 40% of the height extension, and particularly preferably over the upper 50% of the height extension.

The upper region of the battery housing can be designed to accommodate the designated gaseous heat transfer medium located in the battery housing.

The fluid drain of the battery housing can be arranged in the upper region of the battery housing.

The fluid inlet of the battery housing can be arranged in the upper region of the battery housing.

A “heat exchanger” is a device that is designed to be capable of transferring thermal energy from one material flow to another material flow. Preferably, the material flows of a heat exchanger are spatially separated by a heat-permeable wall.

A “collecting container” can be understood to mean any container that is suitable for collecting a fluid in an enclosed interior space. In particular, a collecting container can hold a liquid and/or gaseous fluid or fluid mixture. A collecting container can expediently hold a dielectric fluid and further expediently a dielectric heat transfer medium.

The collecting container may have a “lower region.” The lower region of the collecting container can also extend over the lower 10% of the height extension of the collecting container, wherein the height extension is understood to mean the absolute height extension from the lowest point of the collecting container to the highest point of the collecting container, preferably over the lower 20% of the height extension, again preferably over the lower 30% of the height extension, again preferably over the lower 40% of the height extension, and particularly preferably over the lower 50% of the height extension. Furthermore, the lower region of the collecting container can extend over the lower 60% of the height extension, preferably over the lower 70%, and particularly preferably over the lower 80% of the height extension of the collecting container.

The lower region of the collecting container can be designed to receive the designated liquid heat transfer medium in the collecting container.

In the particularly preferred embodiment of a temperature control system designed for two-phase immersion cooling, the lower region of the collecting container can be designed to accommodate a liquid phase of the heat transfer medium. Preferably, a mixed phase and/or a gaseous phase of the heat transfer medium can be accommodated in a region above the lower region of the collecting container.

The fluid drain of the collecting container can be arranged in the lower region of the collecting container.

The fluid inlet of the collecting container can be arranged in the lower region of the collecting container.

The collecting container may have an “upper region.” The upper region of the collecting container can also extend over the upper 5% of the height extension of the collecting container, preferably over the upper 10% of the height extension, again preferably over the upper 15% of the height extension, and again preferably over the upper 20% of the height extension.

The upper region of the collecting container can be designed to receive the designated gaseous heat transfer medium in the collecting container.

The fluid inlet of the collecting container can be arranged in the upper region of the collecting container.

The fluid drain of the collecting container can be arranged in the upper region of the collecting container.

A “pump” can be understood as any type of pump that is designed to convey a fluid.

A “compensation volume” can be understood to mean any volume that is suitable for collecting a fluid in an enclosed interior space. In particular, a compensation volume can hold a liquid and/or gaseous fluid or fluid mixture. A compensation volume can expediently hold a dielectric fluid and further expediently a dielectric heat transfer medium. Preferably, the expansion tank holds only a gaseous fluid.

The compensation volume can be directly or indirectly fluidically connected to the collecting container. Optionally, the compensation volume can be connected to the collecting container via a line. Furthermore, optionally, the compensation volume can be formed integrally with the collecting container, wherein a volume of the collecting container is at least partially separated from the compensation volume, preferably by a partial constriction or an aperture.

The compensation volume can be directly or indirectly fluidically connected to the heat exchanger. Optionally, the compensation volume can be fluidically connected to the heat exchanger via a line. Furthermore, optionally, the compensation volume can be formed integrally with the heat exchanger, wherein a volume of the heat exchanger is at least partially separated from the compensation volume, preferably by a partial constriction or an aperture.

The compensation volume can be structurally formed by an expansion tank. In particular, the expansion tank can be designed as a separate structure, in particular separate from the collecting container.

The compensation volume can have a variable volume; in particular, the compensation volume can have an elastic wall in this context. Alternatively, the compensation volume can have a variable volume due to the adjustability of a rigid wall; in particular, a region of a wall of the compensation volume can be designed to be adjustable.

The compensation volume can have a “lower region.” The lower region of the compensation volume can also extend over the lower 10% of the height extension of the compensation volume, wherein the height extension of the compensation volume is understood to mean the absolute height extension from the lowest point of the compensation volume to the highest point of the compensation volume, preferably over the lower 20% of the height extension, again preferably over the lower 30% of the height extension, again preferably over the lower 40% of the height extension, and particularly preferably over the lower 50% of the height extension. Furthermore, the lower region of the compensation volume can extend over the lower 60% of the height extension, preferably over the lower 70%, and particularly preferably over the lower 80% of the height extension of the compensation volume.

The lower region of the compensation volume can be designed to receive the designated liquid and/or gaseous heat transfer medium in the compensation volume.

The fluid drain of the compensation volume can be arranged in the lower region of the compensation volume.

The fluid inlet of the compensation volume can be arranged in the lower region of the compensation volume.

The battery housing can have an “upper region.” The upper region of the compensation volume can also extend over the upper 5% of the height extension of the compensation volume, preferably over the upper 10% of the height extension, again preferably over the upper 15% of the height extension, and again preferably over the upper 20% of the height extension.

The upper region of the compensation volume can be designed to receive the designated liquid and/or gaseous heat transfer medium in the compensation volume.

The fluid inlet of the compensation volume can be arranged in the upper region of the compensation volume.

The fluid drain of the compensation volume can be located in the upper region of the compensation volume.

The compensation volume can be arranged above the collecting container so that the compensation volume has a higher geodetic height than the collecting container when used as designated in the motor vehicle. In particular, the compensation volume can be arranged such that it can have the highest geodetic height in the temperature control system.

A fluid conveying apparatus can be arranged between the compensation volume and the collecting container, wherein the fluid conveying apparatus is designed to convey a fluid.

Here, a temperature control system, in particular a temperature control system for controlling the temperature of a traction battery of a motor vehicle, is proposed which has a compensation volume.

Hence, according to a first variant, a temperature control system with a single-phase immersion cooling can be implemented. In particular, a temperature control system can be implemented in which a designated heat transfer medium is brought into direct contact with a designated battery cell within the battery housing. For this purpose, the designated heat transfer medium flows directly around the at least one designated battery cell arranged in the battery housing so that the at least one designated battery cell is directly connected to the designated heat transfer medium in a thermally conductive manner. In this way, an improved heat transfer from the at least one designated battery cell to the designated heat transfer medium or from the designated heat transfer medium to the at least one designated battery cell can be achieved.

In single-phase immersion cooling, the heat capacity of the designated available heat transfer medium is used to dissipate or provide the heat, emitted or absorbed by a designated battery cell within the battery housing during designated use of the temperature control system, via a temperature difference in the heat transfer medium by active circulation of the heat transfer medium in the temperature control circuit. The designated heat transfer medium can thereby undergo a designated temperature cycle within the temperature control system.

The temperature control system can be configured to vary the temperature control performance advantageous for the designated battery cell, in particular by varying the designated heat transfer medium volume flow.

The designated heat transfer medium can advantageously release the heat previously absorbed by increasing the temperature during designated use to the environment and/or another fluid circuit that is in an operative relationship with the heat exchanger through the heat exchanger in the temperature control circuit, so that the designated heat transfer medium cools down again and re-enters the battery housing at a lower temperature.

According to a further variant, a temperature control system with two-phase immersion cooling can be implemented. In two-phase immersion cooling, the evaporation enthalpy of a designated heat transfer medium is in particular used to increase the temperature control performance.

According to a further variant, a temperature control system can be designed with a system closed off from the environment. In a system closed off from the environment, no exchange of substances takes place between the environment and the temperature control system. This means that emissions from the temperature control system can be reduced or completely avoided.

According to a further variant, a temperature control system can be designed with a system open to the environment. In a system open to the environment, an exchange of substances with the environment can take place. This allows the temperature range of the environment of the temperature control systems in which the temperature control system can be used to be extended—in particular, to be used as efficiently as possible.

Preferably, the temperature control system is characterized by the following features:
a three-way valve is arranged between the heat exchanger and the battery housing;
the three-way valve is at least indirectly fluidically connected to the collecting container;
the three-way valve is designed to provide a fluidic connection between the battery housing and the heat exchanger and/or a fluidic connection between the battery housing and the collecting container.

In this regard, the following is explained conceptually:

A “three-way valve” is a device that has three connections through which a flowing fluid can be conducted. In particular, the three-way valve can be designed to be controllable so that a fluid can be conducted depending upon the control of the three-way valve.

The three-way valve can be connected directly or indirectly to the heat exchanger and/or the collecting container. In particular, the three-way valve can be arranged adjacent to the battery housing and/or the heat exchanger and/or the collecting container, or can be part of a line between the battery housing and the heat exchanger and/or a line between the battery housing and the collecting container. The three-way valve can be part of the battery housing and/or part of the heat exchanger and/or part of the collecting container. In particular, the three-way valve together with the battery housing and/or the heat exchanger and/or the collecting container can be designed as an integral component.

Electric vehicles with an electric drive are used in different temperature zones surrounding the vehicle, including very cold regions. In order to be able to charge and/or discharge a traction battery even in very cold ambient conditions of around −20° C. with high power density and, if possible, without affecting the service life of the traction battery, it can be advantageous to be able to actively heat a traction battery.

Here, a temperature control system, in particular a temperature control system for controlling the temperature of a traction battery of a motor vehicle, is proposed which has a three-way valve.

Accordingly, a temperature control system, in particular a temperature control system for a traction battery, can be designed with improved cold start capability.

The three-way valve can fluidically connect the drain of the battery housing to the heat exchanger in the designated flow direction of the designated heat transfer medium and/or fluidically connect the battery housing to the collecting container.

When the three-way valve fluidically connects the battery housing to the collecting container, the three-way valve can direct the designated heat transfer medium past the heat exchanger so that the heat transfer medium does not flow through the heat exchanger. In other words, the designated heat transfer medium can be pumped from the collecting container to the battery housing and from there back to the collecting container via the three-way valve. Since the designated heat transfer medium is not conducted through the heat exchanger, it does not release any heat there. In other words, the at least one designated battery cell is no longer being actively cooled by the temperature control circuit. This allows the at least one designated battery cell to be brought more rapidly into a temperature state in which a high power density can be provided. This can improve the cold start capability of the battery system.

The three-way valve can fluidically connect the battery housing to the heat exchanger and the collecting container so that a portion of the designated heat transfer medium volume flow can be guided first through the heat exchanger and then into the collecting container, and a complementary portion of the heat transfer medium volume flow can be conducted past the heat exchanger into the collecting container. In other words, it is possible to set an intermediate state between the fluidic connection between the battery housing and the heat exchanger and the fluidic connection between the battery housing and the collecting container. This allows the temperature control performance of the temperature control system to be adjusted in even finer increments. This can in particular be preferably used during the transition from the phase using the cold start capability to the control operation of the temperature control system.

Particularly expediently, the battery housing has an evaporation device for evaporating the heat transfer medium, and the heat exchanger is designed as a condenser.

In this regard, the following is explained conceptually:

An “evaporation device” is a device in which a material flow can be evaporated while absorbing heat. Advantageously, the material flow takes the form of a volume flow of a designated heat transfer medium.

Further advantageously, an evaporation device is used to dissipate the heat from the at least one designated battery cell of a designated traction battery to a designated liquid heat transfer medium, so that the designated heat transfer medium can evaporate while absorbing this heat.

In other words, in an evaporation device, heat is absorbed from the at least one designated battery cell in a designated heat transfer medium.

A “condenser” is understood to be an embodiment of heat exchanger in which a material flow can be liquefied while releasing heat. Advantageously, the material flow takes the form of a volume flow of a designated heat transfer medium.

Another advantage is that a condenser is used to dissipate the heat in a designated gaseous heat transfer medium to a fluid circuit that is in operative connection with the condenser. The fluid circuit that is in operative connection with the condenser can take the form of the environment and/or another air-conditioning circuit.

In other words, in a condenser, heat is released from a designated heat transfer medium so that the designated heat transfer medium can liquefy.

Here, a temperature control system, in particular a temperature control system for controlling the temperature of a traction battery of a motor vehicle, is proposed which has an evaporation device and a condenser.

For example, a temperature control system, in particular a temperature control system for a traction battery, can be designed with two-phase immersion cooling. Furthermore, a very high power density of the at least one designated battery cell can be achieved.

A designated heat transfer medium can be pumped into the battery housing in the liquid state of aggregation by the pump and can be at least partially evaporated there in the evaporation device of the battery housing by absorbing the heat from the at least one designated battery cell. In this way, the evaporation enthalpy of the designated heat transfer medium can also be used to dissipate a larger amount of heat from the at least one designated battery cell compared to single-phase immersion cooling. In addition, improved heat transfer can be achieved through the direct contact between the at least one designated battery cell and the designated heat transfer medium.

The pump can also provide a designated heat transfer medium volume flow, through which a constant heat dissipation of the heat of the at least one designated battery cell can be achieved. This makes it possible to achieve a temporally and spatially homogeneous temperature distribution of the at least one designated battery cell. This allows an optimal temperature control of the at least one designated battery cell to be achieved. In particular, this makes it possible to achieve a temporally and spatially homogeneous temperature distribution of the at least one designated traction battery. In this way, an optimal operation with maximum power density of the at least one designated traction battery can be achieved.

After leaving the battery housing, the gaseous designated heat transfer medium can, while releasing heat, be liquefied again in a condenser. After being liquefied, it can be pumped back into the collecting container by the pump. From there, it can be pumped back into the battery housing in order to remove the heat there from at least one designated battery cell by evaporation.

Tests have shown that an advantageous temperature distribution with simultaneous temperature control efficiency can be achieved with a wet steam content less than or equal to 75%, preferably less than or equal to 60%, preferably less than or equal to 53%, and particularly preferably less than or equal to 50%. Furthermore, an advantageous temperature distribution with simultaneous temperature control efficiency can be achieved with a wet steam content less than or equal to 45%, preferably less than or equal to 40%, and particularly preferably less than or equal to 35%. In particular, it has been shown that a wet steam content less than or equal to 50% can contribute to a particularly homogeneous temperature control of the battery cell. In other words, any inhomogeneity in the temperature control of the at least one battery cell can be reduced or prevented by the wet steam content proposed here.

Furthermore, tests have shown that an advantageous temperature distribution with simultaneous temperature control efficiency is achieved with a wet steam content greater than or equal to 1%, preferably greater than or equal to 10%, preferably greater than or equal to 20%, and particularly preferably greater than or equal to 35%. Furthermore, an advantageous temperature distribution with simultaneous temperature control efficiency is achieved with a wet steam content greater than or equal to 45%, preferably greater than or equal to 50%, particularly preferably greater than or equal to 53%.

The wet steam content can be calculated using a heat balance, in particular a heat balance around the battery housing. From a current flowing through a designated battery cell contained in the battery housing and a temperature of this designated battery cell, a heat loss input of this designated battery cell can be calculated. From a heat balance together with a designated heat transfer medium volume flow, the wet steam content of a designated heat transfer medium can now be determined, in particular the wet steam content at the fluid drain of the battery housing. The designated heat transfer medium volume flow can be generated and adjusted with the pump, in particular by changing a pump manipulated variable. The wet steam content can be adjusted by the pump, in particular the wet steam content at the fluid drain of the battery housing, in particular by varying the heat transfer medium volume flow, in particular by changing a pump manipulated variable. This calculation of the wet steam content can be transferred to a traction battery having a large number of battery cells.

Since the thermal energy of the liquid portion of the heat transfer medium that can be absorbed by a temperature change is small compared to the thermal energy that can be absorbed by evaporation of the heat transfer medium, the wet steam content can be determined, in particular determined to a good approximation, in particular the wet steam content at the fluid drain of the battery housing, without determining a temperature of the liquid heat transfer medium, in particular a temperature of the liquid heat transfer medium at the fluid inlet of the battery housing. A temperature sensor, in particular a temperature sensor at the fluid inlet of the battery housing, can increase the accuracy of the determination of the wet steam content of the designated heat transfer medium.

In particular, the wet steam content in the two-phase region can be determined from a pressure of the designated heat transfer medium, in particular the pressure of the designated heat transfer medium at the fluid inlet of the battery housing, and a current flowing through a designated battery cell accommodated in the battery housing. At a constant temperature of the designated heat transfer medium in the two-phase range, the specific heat capacity of the designated heat transfer medium depends upon the pressure of the designated heat transfer medium. Together with the heat transfer medium volume flow, the amount of heat absorbed can be determined using this. Based upon test data with the specific heat transfer medium, in particular test data taking into account the proportion of the heat transfer medium in the fluid or the foreign component in addition to the heat transfer medium, the specific heat capacity of the fluid and from this the wet steam content of the fluid can be determined from the pressure.

Optionally, the pump is a diaphragm pump, in particular a diaphragm pump which is designed to change the pumping direction.

In this regard, the following is explained conceptually:

A “diaphragm pump” is understood to be a device having a movable diaphragm for conveying liquids and/or gases, which is particularly insensitive to continuous stress and impurities in the conveyed material and is therefore particularly robust. In particular, the diaphragm pump can pump two-phase flows, i.e., a mixture of liquid and gaseous phases.

Another advantage of the diaphragm pump is that it can be designed to be directionally reversible. In other words, the diaphragm pump can be designed so that it can pump fluid in two flow directions, in particular two opposite flow directions.

Thus, a temperature control system, in particular a temperature control system for a traction battery, can be designed with a two-phase immersion cooling system with improved cold start capability.

A reversible diaphragm pump with the ability to pump two-phase flows can, depending upon the selected pumping direction, pump a designated heat transfer medium from the lower region of the battery housing and/or from the upper region of the battery housing. In other words, a designated fluid volume flow, in particular a designated heat transfer medium volume flow, can be conveyed in both directions of the temperature control circuit.

In this way, a heating effect on the at least one designated battery cell can be achieved by causing vapor condensation within the battery housing. In this way, an advantageous temperature for the operation of the at least one designated battery cell with optimal power density and/or a homogeneous temperature distribution within the battery housing can be achieved more quickly.

Alternatively, the temperature control system can comprise a first three-way valve and a second three-way valve. The second three-way valve can be located between the pump and the battery housing. The second three-way valve can be fluidically connected to the pump with its first connection, fluidically connected to the battery housing with its second connection, and fluidically connected to the collecting container with its third connection. The first three-way valve can be fluidically connected to the battery housing with its first connection, to the heat exchanger with its second connection, and to the pump with its third connection.

The first three-way valve and the second three-way valve can be designed to be controllable and/or regulatable in such a way that the heat transfer medium can be conveyed from the pump via the first three-way valve into the battery housing, in particular through the fluid drain of the battery housing into the battery housing. The heat transfer medium can be pumped from the battery housing back into the collecting container through the second three-way valve. In other words, the flow direction of the heat transfer medium through the battery housing can be reversed, in particular with a conventional pump. In this way, a heating function can be achieved for at least one battery cell designated to be accommodated in the battery housing.

Alternatively, the temperature control system can comprise a first three-way valve and a second three-way valve. The first three-way valve can be fluidically connected with its first connection to the battery housing, with its second connection to the heat exchanger, and with its third connection to the third connection of the second three-way valve. The second three-way valve can be arranged between the heat exchanger and the collecting container. The second three-way valve can be fluidically connected to the heat exchanger with its first connection, fluidically connected to the collecting container with its second connection, and fluidically connected to the third connection of the first three-way valve with its third connection. With the arrangement of the first and second three-way valves proposed here, it can be achieved that the designated heat transfer medium can optionally flow around the condenser. The first three-way valve and the second three-way valve can be combined in a multi-way valve, in particular a five-way valve, so that they form a structural unit.

A structural unit of a plurality of three-way valves in the form of a multi-way valve, in particular a five-way valve, can also advantageously be transferred to a different arrangement and also a different number of three-way valves.

The temperature control system can include a third three-way valve and a fourth three-way valve. The temperature control system can have a first connecting element and/or a second connecting element. The third three-way valve and/or the fourth three-way valve can be arranged between the pump and the collecting container. The third three-way valve can be fluidically connected with its first connection to the second connection of the fourth three-way valve, with its second connection to the collecting container, and with its third connection to the third connection of a second connecting element. The fourth three-way valve can be fluidically connected with its first connection to the third connection of a first connecting element, with its second connection to the first connection of the third three-way valve, and with its third connection to the pump.

The first connecting element and/or the second connecting element can be designed as a three-way valve or as a T-piece or as another connecting element with three connections. The first connecting element and/or the second connecting element can be arranged between the battery housing and the pump. The first connecting element can be fluidically connected with its first connection to the battery housing, with its second connection to the first connection of the second connecting element, and with its third connection to the first connection of the fourth three-way valve. The second connecting element can be fluidically connected with its first connection to the second connection of the first connecting element, with its second connection to the pump, and with its third connection to the third connection of the third three-way valve.

The third three-way valve and the fourth three-way valve can, in particular in operative connection with the first connecting element and the second connecting element, advantageously reverse the designated flow direction of the designated heat transfer medium in the temperature control system, wherein the conveying direction of the pump can remain the same.

The first three-way valve and/or the second three-way valve and/or the third three-way valve and/or the fourth three-way valve and/or the first connecting element and/or the second connecting element can be designed to be controllable and/or regulatable such that the designated heat transfer medium, in particular the liquid designated heat transfer medium, can be conveyed by the pump from the battery housing into the collecting container. As a result, gaseous designated heat transfer medium from the collecting container, in particular gaseous heat transfer medium generated by a heating element in the collecting container, can be suctioned into the battery housing. In other words, the flow direction of the designated heat transfer medium through the battery housing can be reversed, in particular with a conventional pump. The gaseous designated heat transfer medium thus conveyed into the battery housing can condense on at least one designated battery cell accommodated in the battery housing. This allows this designated battery cell to be heated particularly rapidly. In particular, a heating function with a pronounced phase heating can be achieved.

The third three-way valve and the fourth three-way valve can be combined in a multi-way valve, in particular a five-way valve, so that they form a structural unit. In this case, the multi-way valve has a fluidic connection to the collecting container and a fluidic connection to the pump, in particular to a suction side of the pump. The first and/or the second connecting element can also be integrated into the above multi-way valve, whereby the multi-way valve has a fluidic connection to the battery housing and/or a second fluidic connection to the pump, in particular to a pressure side of the pump.

According to a particularly preferred embodiment, the compensation volume is designed as a pressure compensation device with a variable volume.

In this regard, the following is explained conceptually:

A compensation volume designed as a “pressure compensation device” is understood to mean any compensation volume that is suitable for varying the pressure within the temperature control system by a change in volume.

For this purpose, the pressure compensation device can have a variable volume, in particular a passive variable volume. The variable volume can be set so that it increases when the pressure inside the temperature control system is greater than the pressure in the environment of the temperature control system, and it decreases when the pressure inside the temperature control system is less than the pressure in the environment of the temperature control system. The variable volume can vary its size in such a way that a minimum pressure within the temperature control system cannot be undershot, and a maximum pressure within the temperature control system cannot be exceeded.

The variable volume can be designed as a membrane which can have at least one surface which can be directly connected to the environment and by means of which the volume of the pressure compensation device can be varied. Alternatively, the variable volume can be designed to be balloon-shaped.

This allows a temperature control system to be designed that reacts to pressure differences in the environment of the temperature control system with a change in the volume of the pressure compensation device and is at the same time closed to the environment.

In a system that is closed off from the environment, no exchange of substances can take place between the environment and the temperature control system. This means that emissions from the temperature control system can be reduced or completely avoided.

Furthermore, in a system closed off from the environment, the material compositions within the temperature control system, in particular those of a designated heat transfer medium, can be kept constant, in particular at least partially constant. In particular, the entry of non-condensible substances and/or substance mixtures into the temperature control system and the temperature control circuit can be at least partially prevented, in particular completely prevented. As a result, the temperature control performance of the temperature control system can be kept largely constant even over long periods of time, in particular kept constant, in particular regardless of the ambient conditions.

Furthermore, the pressure compensation device can regulate the pressure within the temperature control system by changing the volume in such a way that a sufficiently high temperature control performance and/or a particularly efficient temperature control can be achieved even at particularly low and/or particularly high temperatures. At low temperatures, the volume within the temperature control system can be reduced by the variable volume of the pressure compensation device in such a way that the pressure within the temperature control system drops only to the extent that sufficient temperature control performance and/or particularly efficient temperature control can be guaranteed. Furthermore, the volume within the temperature control system can be increased at high temperatures by the variable volume of the pressure compensation device in such a way that the pressure within the temperature control system only increases to the extent that individual components of the temperature control system cannot thereby experience critical loads.

Optionally, the pressure compensation device has a defined maximum volume.

In this regard, the following is explained conceptually:

A “maximum volume” of a pressure compensation device is understood to be an upper limit for the variable volume of the pressure compensation device.

A maximum volume can be formed by a rigid, non-variable volume surrounding the variable volume of the pressure equalization device. In other words, a maximum volume can have an interior space in which the variable volume can be accommodated and limited. Such a rigid volume surrounding the variable volume can be a hollow cylinder or a hollow cube or the like, which have an interior space in which the variable volume can be accommodated.

A maximum volume can prevent an excessive expansion of the variable volume of the pressure compensation device. This can be advantageous in particular if the variable volume, if expanded too much, could come into unwanted contact with other components of a motor vehicle in which the temperature control system can be installed. This allows the temperature control system to be installed with defined dimensions in a motor vehicle.

Moreover, optionally, the temperature control system has a safety valve against underpressure in the temperature control circuit.

In this regard, the following is explained conceptually:

A “safety valve” is understood to mean any valve that can equalize the pressure in pressurized systems when a specified overpressure is exceeded and/or a specified negative pressure is undershot. In particular, a safety valve can be designed to protect the pressurized system from damage by equalizing the pressure.

Temperature fluctuations can lead to pressure changes in a temperature control system. This can influence the temperature control efficiency of the temperature control system. In particular, the cooling efficiency can be negatively influenced by low temperature and thus lower pressure in the temperature control system.

The safety valve can open in the event of an underpressure in the temperature control system relative to the environment, whereby a medium from the environment of the safety valve can enter the temperature control device, and the minimum pressure in the temperature control system can be limited. This allows individual components of the temperature control system to be protected from damage.

Because a medium from the environment can enter the system, it mixes with the heat transfer medium and can influence the temperature control performance. In particular if the medium from the environment is a non-condensible gas, this can reduce the temperature control performance.

Due to the arrangement of the compensation volume chosen in the system, the non-condensible gas can collect in the compensation volume. Due to density differences between the heat transfer medium and the non-condensible gas, a stratification can occur between the non-condensible gas and the heat transfer medium, in particular the gaseous phase of the heat transfer medium, so that the non-condensible gas can collect in the compensation volume, in particular if the compensation volume is arranged such that it has the highest geodetic height in the temperature control system. In other words, the non-condensible gas can collect above the gaseous phase of the heat transfer medium because the density of the non-condensible gas is lower than the density of the gaseous phase of the heat transfer medium.

This can reduce the influence of the non-condensed gas on the temperature control performance, in particular if the compensation volume has a variable volume.

The safety valve can be designed so that, in the event of a negative pressure in the temperature control system in relation to the environment of the temperature control system, the maximum negative pressure in the temperature control system is less than or equal to 0.03 N/mm², preferably less than or equal to 0.02 N/mm², preferably less than or equal to 0.015 N/mm², and particularly preferably less than or equal to 0.0125 N/mm². Furthermore, the safety valve can be designed so that the maximum negative pressure in the temperature control system is less than or equal to 0.01 N/mm², preferably less than or equal to 0.0075 N/mm², preferably less than or equal to 0.005 N/mm², and particularly preferably less than or equal to 0.0025 N/mm².

The temperature control system expediently has a safety valve against overpressure in the temperature control circuit.

It is proposed here that the temperature control system have a safety valve which is configured to open in the event of an overpressure in the temperature control system compared to the environment. This allows a medium to escape from the temperature control system into the environment, and the maximum pressure in the temperature control system can be limited.

The safety valve can be designed so that, in the event of an overpressure in the temperature control system in relation to the environment of the temperature control system, the maximum overpressure in the temperature control system is less than or equal to 0.31 N/mm², preferably less than or equal to 0.285 N/mm², preferably less than or equal to 0.265 N/mm², and particularly preferably less than or equal to 0.25 N/mm². Furthermore, the safety valve can be designed so that the maximum overpressure in the temperature control system is less than or equal to 0.235 N/mm², preferably less than or equal to 0.22 N/mm², preferably less than or equal to 0.2 N/mm², and particularly preferably less than or equal to 0.175 N/mm².

Preferably, the temperature control system has a sensor, wherein the sensor is configured to determine the conductivity of a medium in the temperature control circuit.

If the proportion of a designated heat transfer medium in the temperature circuit falls below a certain value, this can affect the temperature control performance of the temperature control system.

Furthermore, the temperature control system preferably has a first sensor and a second sensor, each configured to determine the conductivity of a medium in the temperature control circuit, wherein the first sensor is in fluidic communication with the lower region of the battery housing, and the second sensor is in fluidic communication with an upper region of the battery housing.

With a second sensor, the measurement accuracy of the conductivity of a medium can be increased. The conductivity can be used to determine a property of a fluid. In particular, it can be determined whether contamination with other fluid components is present. Such contamination can influence the conductivity of a fluid, in particular of a heat transfer medium.

Furthermore, the temperature control system can have a third sensor, in particular a sensor which is designed to determine a temperature of the designated heat transfer medium. In particular, the third sensor can be in fluidic communication with the lower region of the battery housing, preferably at the fluid inlet of the battery housing.

Furthermore, the temperature control system can have a fourth sensor, in particular a sensor which is designed to determine a pressure of the designated heat transfer medium in the temperature control system. In particular, the fourth sensor can be in fluidic communication with the lower region of the battery housing, preferably at the fluid inlet of the battery housing.

Preferably, the collecting container has a heating element.

In this regard, the following is explained conceptually:

A “heating element” is understood to be a device from which heat can be dissipated to the fluid surrounding the heating element. In other words, the heating element can heat the fluid that surrounds the heating element.

In particular, the collecting container can have a heating element which is designed to achieve an advantageous temperature in the collecting container.

As a result, the designated heat transfer medium fed into the battery housing by the pump can enter the battery housing at an increased temperature so that heat can be released to the at least one designated battery cell due to the increased temperature of the designated heat transfer medium. This makes it possible for a designated battery cell to provide or absorb a high power density more quickly, even at low ambient temperatures. This can improve the cold-start capability.

The heat exchanger is, conveniently, fluidically connected to the compensation volume.

The heat exchanger can preferably be connected in the upper region of the heat exchanger and/or the lower region of the heat exchanger to the upper region of the compensation volume and/or the lower region of the compensation volume.

In condensers, gaseous components of a medium can, during operation, remain due to incomplete condensation of the medium. In particular, a non-condensible gas can accumulate in the upper region of the condenser.

Because the heat exchanger and the compensation volume can be fluidically connected, liquid and/or gaseous fluid can be led from the heat exchanger to the compensation volume. In particular, a gaseous component of a not completely condensed designated heat transfer medium can be led from the heat exchanger to the compensation volume. Furthermore, non-condensible gas in particular can be led from the heat exchanger to the compensation volume. Finally, in particular non-condensible fluid, which may have entered the temperature control system through a safety valve, can be led from the heat exchanger to the compensation volume.

Optionally, the temperature control system has a fluid conveying apparatus, wherein the fluid conveying apparatus can be arranged between the collecting container and the compensation volume.

In this regard, the following is explained conceptually:

A “fluid conveying apparatus” is any device for conveying a liquid and/or gaseous substance and/or mixture of substances.

The fluid conveying apparatus can convey fluid, in particular a designated heat transfer medium, from the collecting container into the compensation volume.

The temperature control system can have a filling device.

In this regard, the following is explained conceptually:

A “filling apparatus” is understood to mean any device for filling a temperature control system with a fluid. In particular, a filling device is understood to be a device with which a temperature control system can be filled with a designated heat transfer medium.

The filling device can preferably be arranged above the battery housing. Furthermore, the filling device can preferably be arranged below a safety valve. Preferably, the filling apparatus can be arranged between the heat exchanger and the collecting container. Particularly preferably, the filling device can be arranged adjacent to the collecting container, again preferably in the upper region of the collecting container. Finally, the filling device can be arranged integrally with the collecting container, preferably in the upper region of the collecting container.

The temperature control system can include a drainage device.

In this regard, the following is explained conceptually:

A “drainage device” is understood to mean any device for draining a fluid from a temperature control system. In particular, a drainage device is understood to mean a device for draining a designated heat transfer medium from a temperature control system.

The drainage device can preferably be arranged at the point with the lowest geodetic height of the system. Preferably, the drainage device can be arranged in the lower region of the battery housing. Further preferably, the drainage device can be integrally connected to the lower region of the battery housing.

One or more components of the temperature control system can be arranged inside the motor vehicle, in particular the battery housing of the traction battery, and/or the collecting container, and/or the heat transfer device, and/or the pump, and/or the compensation volume.

According to a second aspect of the invention, the object is achieved by a motor vehicle having a temperature control system according to the first aspect of the invention.

It should be understood that the advantages of a temperature control system according to the first aspect of the invention, as described above, extend directly to a motor vehicle having a temperature control system according to the first aspect of the invention.

It should be expressly noted that the subject matter of the second aspect can advantageously be combined with the subject matter of the preceding aspect of the invention, both individually or cumulatively in any combination.

Further advantages, details, and features of the invention can be found below in the described embodiments. In the figures, in detail:

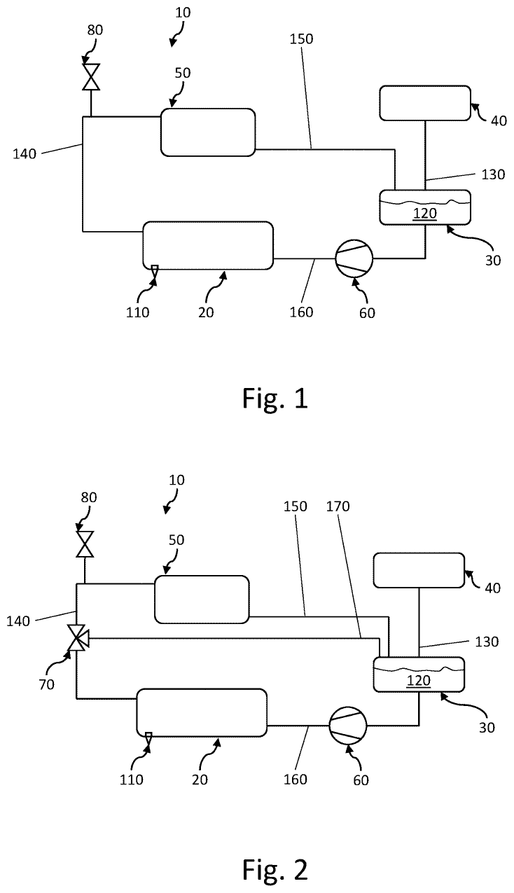

FIG. 1 is a schematic representation of a first embodiment of a temperature control system;

FIG. 2 is a schematic representation of a second embodiment of a temperature control system;

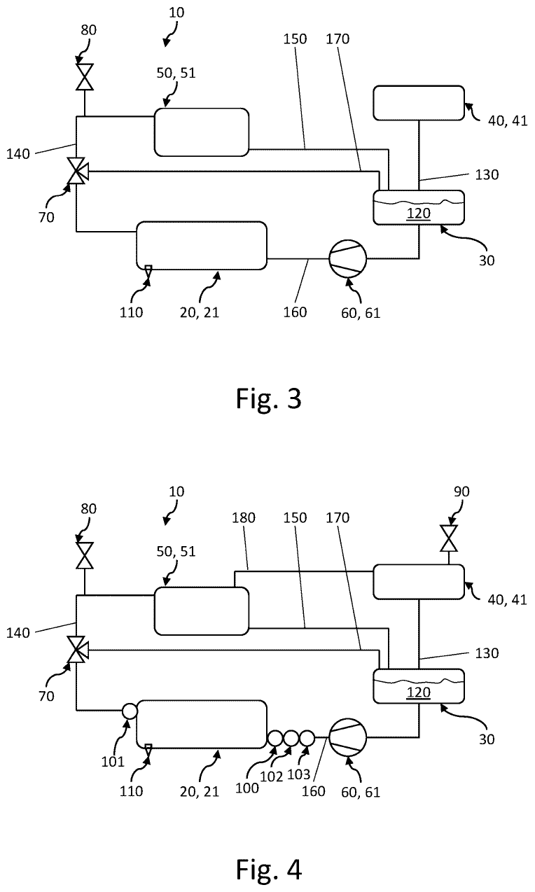

FIG. 3 is a schematic representation of a third embodiment of a temperature control system;

FIG. 4 is a schematic representation of a fourth embodiment of a temperature control system; and

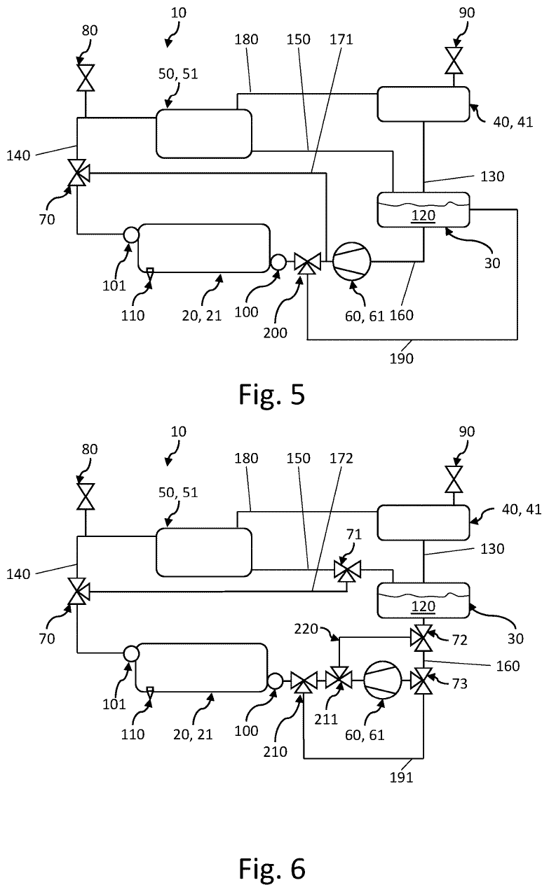

FIG. 5 is a schematic representation of a fifth embodiment of a temperature control system; and

FIG. 6 is a schematic representation of a sixth embodiment of a temperature control system.

In the following description, the same reference signs denote the same components or features; in the interest of avoiding repetition, a description of a component made with reference to one drawing also applies to the other drawings. Furthermore, individual features that have been described in connection with one embodiment can also be used separately in other embodiments.

A first embodiment of a temperature control system 10 according to FIG. 1 consists essentially of a battery housing 20, a heat exchanger 50, a collecting container 30, and a pump 60.

The temperature control system 10 can be configured to control the temperature of a traction battery of a motor vehicle using a heat transfer medium 120 in a temperature control circuit.

The battery housing 20 can have an enclosed interior with at least one receiving position for a battery cell, wherein a lower region of the battery housing 20 can be designed to receive the heat transfer medium 120.

The heat exchanger 50 can be designed to dissipate heat from the heat transfer medium 120 to the environment surrounding the heat exchanger 50.

The collecting container 30 can be designed to hold the heat transfer medium 120.

Even if the temperature control circuit is described below while simultaneously mentioning lines 130, 140, 150, 160, 170, 180, it should be expressly pointed out that the lines 130, 140, 150, 160, 170, 180 should also be understood as optional, and components of the temperature control circuit functionally connected to each other can also be arranged directly adjacent to one another, so that individual, several, or all lines 130, 140, 150, 160, 170, 180 can be dispensed with.

The heat exchanger 50 can be fluidically connected to the battery housing 20 at least indirectly through a second line 140 and to the collecting container 30 at least indirectly through the third line 150. The collecting container 30 can be fluidically connected to the battery housing 20 at least indirectly via a fourth line 160. The pump 60 can be arranged between the battery housing 20 and the collecting container 30, in operative relationship with the fourth line 160. The pump 60 can be arranged adjacent to the battery housing 20 and/or the collecting container 30 or can be part of the fourth line 160, or the collecting container 30, or the battery housing 20. As a result, the pump 60 can pump the heat transfer medium 120 from the collecting container 30 into the battery housing 20, into the heat exchanger 50, and back into the collecting container 30. In this way, a temperature control of at least one designated battery cell within the battery housing 20 can be achieved.

The temperature control system 10 can have a compensation volume 40. The compensation volume 40 can be at least indirectly fluidically connected to an upper region of the collecting container 30 through a first line 130, or can be directly connected to the collecting container 30, or can be formed integrally with the collecting container 30, wherein a volume of the collecting container 30 is at least partially separated from the compensation volume 40 by a partial constriction or an aperture.

The temperature control system 10 can also have a drainage device 110. The drainage device 110 can be arranged at the lowest point of the temperature control system 10. The drainage device 110 can be arranged in the lower region of the battery housing 20 or in the fourth line 160. The temperature control system 10 can also have a filling apparatus 80 which can preferably be arranged at the highest point of the temperature control system 10. The filling apparatus 80 can be arranged above the battery housing 20.

A second embodiment of a temperature control system 10 according to FIG. 2 can have a heating function for heating the at least one designated battery cell. For this purpose, the second embodiment of the temperature control system 10 can have a three-way valve 70.

The three-way valve 70 can be arranged between the battery housing 20 and the heat exchanger 50, preferably as part of the second line 140 or immediately adjacent to the battery housing 20 and/or the heat exchanger 50. Furthermore, it is conceivable that the three-way valve 70 be a component of the battery housing 20 or the heat exchanger 50. The three-way valve 70 can be at least indirectly fluidically connected to the battery housing 20 through its first connection and to the heat exchanger 50 through its second connection. With its third connection, the three-way valve 70 can be fluidically connected to the collecting container 30 at least indirectly through the fifth line 170. However, the three-way valve can also be directly adjacent to the collecting container 30 or be an integral part of the collecting container 30.

The three-way valve 70 can also be designed to be controllable. In particular, the three-way valve 70 can be designed to be controllable in such a way that the heat transfer medium 120 can be pumped by the pump 60 from the collecting container 30, preferably through the fourth line 160, into the battery housing 20, and, from there, preferably through the second line 140 and/or the fifth line 170, back into the collecting container 30. In other words, the three-way valve 70 can be designed to be controllable such that the heat transfer medium 120 is not conveyed through the heat exchanger 50 and/or the line 150. In this way, a heating function of the temperature control system 10 can be achieved.

The representation of the pump 60 is not decisive for the conveying direction of the heat transfer medium 120. In other words, the pump can be configured to pump in two opposite pumping directions.

A third embodiment of a temperature control system 10 according to FIG. 3 can have a heat exchanger 50 which can be designed as a condenser 51. The battery housing 20 can be designed as a battery housing 21 which has an evaporation device for evaporating the heat transfer medium 120. The pump 60 can be designed as a diaphragm pump 61. In particular, the diaphragm pump 61 can be designed to change the pumping direction. This allows two-phase immersion cooling to be carried out with the temperature control system 10.

The temperature control system 10 according to FIG. 3 can have a compensation volume 40 which is designed as a pressure compensation device with a variable volume 41. In particular, the pressure compensation volume with a variable volume 41 can have a defined maximum volume. This allows the temperature control system 10 to be operated as a system closed to the environment.

A fourth embodiment of a temperature control system 10 according to FIG. 4 can have a sixth line 180. The heat exchanger 50, 51 can be fluidically connected to the compensation volume 40, 41 through the sixth line 180, or can be directly fluidically connected to the compensation volume 40, 41.

The temperature control system 10 can have a safety valve 90 against underpressure and/or against overpressure. The safety valve 90 can be arranged at the highest point of the temperature control system 10. In particular, the safety valve 90 can be arranged in the upper region of the compensation volume 40, 41.

The filling device can be arranged below a safety valve 90.

The temperature control system 10 can also have a sensor 100. The first sensor 100 can be configured to determine the conductivity of a medium in the temperature control circuit. The first sensor 100 can be in fluidic communication with the lower region of the battery housing 20. The temperature control system 10 can have a second sensor apparatus 101. The second sensor 101 can be configured to determine the conductivity of a medium in the temperature control circuit. The second sensor 101 can be in fluidic communication with an upper region of the battery housing 20. With a second sensor 101, the measurement accuracy for determining the conductivity of a medium can be increased.

Furthermore, the temperature control system 10 can have a third sensor 102 and/or a fourth sensor 103; in particular, the third sensor 102 and the fourth sensor 103 can be arranged at the fluid inlet of the battery housing 20. The third sensor 102 can be designed to determine a temperature of the designated heat transfer medium 120. The fourth sensor 103 can be designed to determine a pressure of the designated heat transfer medium 120.

The temperature control system 10 can have a fluid conveying apparatus. The fluid conveying apparatus can be arranged in the first line 130 between the collecting container 30 and the compensation volume 40, 41, or can be directly connected to the collecting container 30 and/or the compensation volume 40, 41, or can be integrated into the collecting container 30 or the compensation volume.

A fifth embodiment of a temperature control system 10 according to FIG. 5 can have a valve 200, which can be arranged between the pump 60, 61 and the battery housing 20. In particular, the valve 200 can be designed as a three-way valve. The valve 200 designed as a three-way valve can be fluidically connected with its first connection to the pump 60, 61, fluidically connected with its second connection to the battery housing 20, and fluidically connected with its third connection, in particular at least indirectly by a seventh line 190, to the collecting container 30. In this embodiment, the three-way valve 70 can be fluidically connected with its third connection to the pump 60, 61, in particular at least indirectly through a fifth line 171.

The three-way valve 70 and the valve 200 can also be designed to be controllable and/or regulatable, in particular such that the heat transfer medium 120 can be conveyed from the pump 60, 61 via the three-way valve 70 into the battery housing 20, in particular through the fluid drain of the battery housing 20. From the battery housing 20, the heat transfer medium 120 can be conveyed through the valve 200 back into the collecting container 30. In other words, the conveying direction of the heat transfer medium 120 through the battery housing 20 can be reversed. In this way, a heating function can be achieved for at least one battery cell designated to be accommodated in the battery housing 20.

A sixth embodiment of a temperature control system 10 according to FIG. 6 can have a three-way valve 70 and a second three-way valve 71. The three-way valve 70 can be arranged between the battery housing 20 and the heat exchanger 50, in particular in the second line 140. The second three-way valve 71 can be arranged between the heat exchanger 50 and the collecting container 30, in particular in the third line 150. The three-way valve 70 can be fluidically connected with its first connection to the battery housing 20, 21, with its second connection to the heat exchanger 50, 51, and with its third connection to the third connection of the second three-way valve 71. The second three-way valve 71 can be arranged between the heat exchanger 50, 51 and the collecting container 30. The second three-way valve 71 can be fluidically connected to the heat exchanger 50, 51 with its first connection, fluidically connected to the collecting container 30 with its second connection, and fluidically connected to the third connection of the three-way valve 70 with its third connection.

The temperature control system 10 can have a third three-way valve 72 and a fourth three-way valve 73. The temperature control system 10 can have a first connecting element 210 and/or a second connecting element 211. The third three-way valve 72 and/or the fourth three-way valve 73 can be arranged between the pump 60, 61 and the collecting container 30, in particular in the fourth line 160. The third three-way valve 72 can be fluidically connected with its first connection to the second connection of the fourth three-way valve 73, with its second connection to the collecting container 30, and with its third connection to the third connection of a second connecting element 211. The fourth three-way valve 73 can be fluidically connected with its first connection to the third connection of a first connecting element 210, with its second connection to the first connection of the third three-way valve 72, and with its third connection to the pump 60, 61.

The first connecting element 210 and/or the second connecting element 211 can be designed as a three-way valve or as a T-piece, or as another connecting element with three connections. The first connecting element 210 and/or the second connecting element 211 can be arranged between the battery housing 20, 21 and the pump 60, 61, in particular in the fourth line 160. The first connecting element 210 can be fluidically connected with its first connection to the battery housing 20, 21, with its second connection to the first connection of the second connecting element 211, and with its third connection to the first connection of the fourth three-way valve 73. In particular, the first connecting element 210 can be fluidically connected with its third connection to the first connection of the fourth three-way valve 73 via the seventh line 191. The second connecting element 211 can be fluidically connected with its first connection to the second connection of the first connecting element 210, with its second connection to the pump 60, 61, and with its third connection to the third connection of the third three-way valve 72. In particular, the second connecting element 211 can be fluidically connected with its third connection to the third connection of the third three-way valve 72 via the eighth line 220.

The three-way valve 70 and/or the second three-way valve 71 and/or the third three-way valve 72 and/or the fourth three-way valve 73 and/or the first connecting element 210 and/or the second connecting element 211 can be designed to be controllable and/or regulatable such that the designated heat transfer medium 120, in particular the liquid designated heat transfer medium 120, can be conveyed by the pump 60, 61 from the battery housing 20, 21 into the collecting container 30. As a result, gaseous designated heat transfer medium 120 can be suctioned from the collecting container 30 into the battery housing 20, 21. In other words, the flow direction of the designated heat transfer medium 120 through the battery housing 20, 21 can be reversed, in particular with a conventional pump 60. The gaseous designated heat transfer medium 120 thus conveyed into the battery housing 20, 21 can condense on at least one designated battery cell accommodated in the battery housing 20, 21. This allows this designated battery cell to be heated particularly rapidly. In particular, a heating function with a pronounced phase heating can be achieved.

### LIST OF REFERENCE SIGNS

10 temperature control system
20 battery housing
21 battery housing with evaporation device
30 collecting container
40 compensation volume
41 variable volume pressure equalization device
50 heat exchanger
51 condenser
60 pump
61 diaphragm pump
70 three-way valve
71 second three-way valve
72 third three-way valve
73 fourth three-way valve
80 filling device
90 safety valve (against low pressure/excess pressure)
100 first sensor
101 second sensor
102 third sensor
103 fourth sensor
110 drainage device
120 heat transfer medium
130 first line
140 second line
150 third line
160 fourth line
170 fifth line
171 fifth line
172 fifth line
180 sixth line
190 seventh line
191 seventh line
200 valve
210 first connecting element
211 second connecting element
220 eighth line

1. A temperature control system for controlling the temperature of a traction battery of a motor vehicle using a heat transfer medium in a temperature control circuit, the temperature control system comprising:
a battery housing which forms an enclosed interior with at least one receiving position for at least one battery cell, wherein a lower region of the battery housing is designed to receive the heat transfer medium;
a heat exchanger which is designed to dissipate heat from the heat transfer medium to an environment surrounding the heat exchanger,
a collecting container for receiving the heat transfer medium,
a pump for conveying the heat transfer medium, and
a compensation volume which is fluidically connected to an upper region of the collecting container.

2. The temperature control system according to claim 1, wherein:
a three-way valve is arranged between the heat exchanger and the battery housing;
the three-way valve is at least indirectly fluidically connected to the collecting container;
the three-way valve is designed to provide a fluidic connection between the battery housing and the heat exchanger and/or a fluidic connection between the battery housing and the collecting container.

3. The temperature control system according to claim 1, wherein:
the battery housing has an evaporation device for evaporating the heat transfer medium, and
the heat exchanger is designed as a condenser.

4. The temperature control system according to claim 1, wherein the pump is a diaphragm pump, in particular a diaphragm pump which is designed to change a pumping direction.

5. The temperature control system according to claim 1, wherein the compensation volume is designed as a pressure compensation device with a variable volume.

6. The temperature control system according to claim 5, wherein the pressure compensation device has a defined maximum volume.

7. The temperature control system according to claim 1, wherein the temperature control system has a safety valve against a negative pressure in the temperature control circuit.

8. The temperature control system according to claim 1, wherein the temperature control system has a safety valve against an overpressure in the temperature control circuit.

9. The temperature control system according to claim 1, wherein the temperature control system has a sensor, wherein the sensor is configured to determine a conductivity of a medium in the temperature control circuit.

10. The temperature control system according to claim 9, wherein the temperature control system preferably has a first sensor and a second sensor, each configured to determine the conductivity of a medium in the temperature control circuit, and
wherein the first sensor is in fluidic communication with the lower region of the battery housing, and the second sensor is in fluidic communication with an upper region of the battery housing.

11. The temperature control system according to claim 1, wherein the collecting container has a heating element.

12. The temperature control system according to claim 1, wherein the heat exchanger is fluidically connected to the compensation volume.

13. A motor vehicle having a temperature control system, the motor vehicle comprising:
a battery housing which forms an enclosed interior with at least one receiving position for at least one battery cell, wherein a lower region of the battery housing is designed to receive a heat transfer medium;
a heat exchanger which is designed to dissipate heat from the heat transfer medium to an environment surrounding the heat exchanger,
a collecting container for receiving the heat transfer medium,
a pump for conveying the heat transfer medium, and
a compensation volume which is fluidically connected to an upper region of the collecting container.
